(19) United States
(12) Patent Application Publication
(10) Pub. No.: US 2026/0051750 A1
(43) Pub. Date: Feb. 19, 2026

(54) SYSTEM AND METHOD FOR CONTROLLING PARALLEL CONNECTED BATTERIES

(71) Applicants: Hyundai Motor Company, Seoul (KR); Kia Corporation, Seoul (KR)

(72) Inventor: Sungho Kim, Hwaseong-Si (KR)

(21) Appl. No.: 19/172,230

(22) Filed: Apr. 7, 2025

(30) Foreign Application Priority Data
Aug. 19, 2024 (KR) 10-2024-0110546

(51) Int. Cl. H02J 7/00

(52) U.S. Cl. CPC H02J 7/0014; H02J 7/0048; H02J 7/00712; H02J 2207/20

(57) ABSTRACT

A system for controlling a plurality of batteries is introduced. The system may comprise a first battery controller circuit configured to obtain first state information of a first battery and control the first battery based on the first state information. A second battery controller circuit may be configured to obtain second state information of a second battery and control the second battery based on the second state information, wherein the second battery is coupled in parallel to the first battery. A battery integrated controller circuit may be configured to control the first battery controller circuit and the second battery controller circuit based on aggregated state information of the first state information and the second state information.

### CROSS-REFERENCE TO RELATED PATENT APPLICATION

This application claims the benefit of priority to Korean Patent Application No. 10-2024-0110546, filed in the Korean Intellectual Property Office on Aug. 19, 2024, the entire disclosures of which are hereby incorporated by reference.

### TECHNICAL FIELD

The present disclosure relates to a system and method for controlling a parallel-connected battery, and more particularly to a system and method for controlling a parallel-connected battery that control charging and discharging of a parallel-connected high-voltage battery used in an electric vehicle, etc.

### BACKGROUND

The matters described in this Background section are only for enhancement of understanding of the background of the disclosure, and should not be taken as acknowledgment that they correspond to prior art already known to those skilled in the art.

An electrified vehicle such as an EV (Electric Vehicle), a HEV (Hybrid Electric Vehicle), a PHEV (Plug-in Hybrid Electric Vehicle), etc. coverts electric energy into mechanical energy to obtain driving force, and a high-voltage battery used here accounts for a large portion of the manufacturing cost of the electrified vehicle.

Consumers may prefer relatively inexpensive electric vehicles having a driving range suitable for city driving rather than long-distance driving. However, since an expensive high-voltage battery having high energy capacity is used, the vehicle price may be high and the charging time may be long, and thus electric vehicle sales may gradually slow down.

Accordingly, an electric vehicle that may lower energy capacity of a main battery and additionally use a swappable battery as an auxiliary battery (for example, when driving long distances) is considered.

### SUMMARY

Therefore, the present disclosure has been made in view of the above problems, and it is an object of the present disclosure to provide a system and method for controlling a parallel-connected battery in which a swappable battery may be used as desired by being added to a main battery fixedly mounted in an electric vehicle, etc.

According to the present disclosure, a system for controlling a plurality of batteries, the system may comprise a first battery controller circuit configured to obtain first state information of a first battery of the plurality of batteries, and control, based on the first state information, the first battery, a second battery controller circuit configured to obtain second state information of a second battery of the plurality of batteries, and control, based on the second state information, the second battery, wherein the second battery is coupled in parallel to the first battery, and a battery integrated controller circuit configured to control, based on aggregated state information of the first state information and the second state information, the first battery controller circuit and the second battery controller circuit.

The system further may comprise a first direct current (DC)-DC converter configured to perform at least one of step-up or step-down of a first voltage of the first battery under control of the first battery controller circuit, and a second DC-DC converter configured to perform at least one of step-up or step-down of a second voltage of the second battery under control of the second battery controller circuit.

The system, wherein the battery integrated controller circuit is configured to control the first battery controller circuit and the second battery controller circuit such that the first DC-DC converter performs the at least one of step-up or step-down of the first voltage, and the second DC-DC converter performs the at least one of step-up or step-down of the second voltage.

The system, wherein, based on being in a charging state and a difference between a state of charge (SoC) of the first battery and an SoC of the second battery exceeding a preset threshold value, the battery integrated controller circuit is configured to control the first battery controller circuit and the second battery controller circuit such that either the first battery or the second battery, whichever has a lower SoC, is charged alone.

The system, wherein, based on being in a discharging state, the battery integrated controller circuit is configured to control, based on a state of charge (SoC) of the first battery being less than an SoC of the second battery, the first battery controller circuit and the second battery controller circuit such that the second battery generates a primary output and the first battery generates a secondary output, wherein the primary output of the second battery corresponds to a maximum output of the second battery, and control, based on the SoC of the first battery not being less than the SoC of the second battery, the first battery controller circuit and the second battery controller circuit such that the first battery generates a primary output and the second battery generates a secondary output, wherein the primary output of the first battery corresponds to a maximum output of the first battery.

The system, wherein, based on being in a discharging state and a difference between a state of charge (SoC) of the first battery and an SoC of the second battery being less than or equal to a preset threshold value, the battery integrated controller circuit is configured to control the first battery controller circuit and the second battery controller circuit such that an output from the first battery is generated based on an energy capacity of the first battery, and an output from the second battery is generated based on an energy capacity of the second battery.

The system, wherein, based being in a standby state and a difference between a state of charge (SoC) of the first battery and an SoC of the second battery exceeding a preset threshold value, the battery integrated controller circuit is configured to control the first battery controller circuit and the second battery controller circuit such that either the second battery or the first battery, whichever has a lower SoC, is balanced through either the first battery or the second battery, whichever has a higher SoC.

The system, wherein, based on being in a safety diagnosis state, the battery integrated controller circuit is configured to control the first battery controller circuit and the second battery controller circuit such that the second battery generates a primary output, corresponding to a maximum output of the second battery, regardless of whether the first battery is allowed to generate an output, and the first battery generates, based on generating an output of the first battery being allowed in the safety diagnosis state, a secondary output.

According to the present disclosure, a method performed by an apparatus may comprise a battery integrated controller circuit, the method may comprise obtaining, by the battery integrated controller circuit, first state information of a first battery of a plurality of batteries and second state information of a second battery of a plurality of batteries, wherein the second battery is coupled in parallel to the first battery, and based on aggregated state information of the first state information and the second state information, controlling, by the battery integrated controller circuit, a first battery controller circuit for controlling the first battery and a second battery controller circuit for controlling the second battery.

The method, wherein, based on being in a charging state and a difference between a state of charge (SoC) of the first battery and an SoC of the second battery exceeding a preset threshold value, the controlling may comprise controlling the first battery controller circuit and the second battery controller circuit such that either the first battery or the second battery, whichever has a lower SoC, is charged alone. The method, wherein, based on being in a discharging state, the controlling may comprise controlling, based on a state of charge (SoC) of the first battery being less than an SoC of the second battery, the first battery controller circuit and the second battery controller circuit such that the second battery generates a primary output and the first battery generates a secondary output, wherein the primary output corresponds to a maximum output of the second battery, and controlling, based on the SoC of the first battery not being less than the SoC of the second battery, the first battery controller circuit and the second battery controller circuit such that the first battery generates a primary output and the second battery generates a secondary output, wherein the primary output of the first battery corresponds to a maximum output of the first battery.

The method, wherein, based on being in a discharging state and a difference between a state of charge (SoC) of the first battery and an SoC of the second battery being less than or equal to a preset threshold value, the controlling may comprise controlling at least one of the first battery controller circuit or the second battery controller circuit such that an output from the first battery is generated based on an energy capacity of the first battery, or an output from the second battery is generated based on an energy capacity of the second battery.

The method, wherein, based on being in a standby state and a difference between a state of charge (SoC) of the first battery and an SoC of the second battery exceeding a preset threshold value, the controlling may comprise controlling the first battery controller circuit and the second battery controller circuit such that either the second battery or the first battery, whichever has a lower SoC, is balanced through either the first battery or the second battery, whichever has a higher SoC.

The method, wherein, based on being in a safety diagnosis state, the controlling may comprise controlling the first battery controller circuit and the second battery controller circuit such that the second battery generates a primary output, corresponding to a maximum output of the second battery, regardless of whether the first battery is allowed to generate an output, and the first battery generates, based on generating an output of the first battery being allowed in the safety diagnosis state, a secondary output.

According to the present disclosure, a system for controlling a plurality of batteries, the system may comprise a plurality of battery controller circuits, each configured to obtain respective state information of a corresponding battery of the plurality of batteries, and control, based on the respective state information, the corresponding battery, wherein the plurality of batteries are coupled in parallel to each other, and a central controller circuit configured to control, based on aggregated state information of the plurality of batteries, the plurality of the battery controller circuits.

The system further may comprise a plurality of direct current (DC)-DC converters, each configured to perform at least one of step-up or step-down of a voltage of a corresponding battery of the plurality of batteries.

The system, wherein, based on being in a charging state and a difference between a state of charge (SoC) of a first battery of the plurality of batteries and an SoC of a second battery of the plurality of batteries exceeding a preset threshold value, the central controller circuit is configured to control the plurality of battery controller circuits such that either of the first battery or the second battery, which has a lower SoC, is charged alone.

The system, wherein, based on being in a discharging state, the central controller circuit is configured to control, based on a state of charge (SoC) of a first battery of the plurality of batteries being less than an SoC of a second battery of the plurality of batteries, a first battery controller circuit of the plurality of battery controller circuits and a second battery controller circuit of the plurality of battery controller circuits such that the second battery generates a primary output and the first battery generates a secondary output, wherein the primary output of the second battery corresponds to a maximum output of the second battery, and control, based on an SoC of the first battery not being less than an SoC of the second battery, the first battery controller circuit and the second battery controller circuit such that the first battery generates a primary output and the second battery generates a secondary output, wherein the primary output of the first battery corresponds to a maximum output of the first battery.

The system, wherein, based on being in a discharging state and a difference between a state of charge (SoC) of a first battery of the plurality of batteries and an SoC of a second battery of the plurality of batteries being less than or equal to a preset threshold value, the central controller circuit is configured to control a first battery controller circuit of the plurality of battery controller circuits and a second battery controller circuit of the plurality of battery controller circuits such that an output from the first battery is generated based on an energy capacity of the first battery, and an output from the second battery is generated based on an energy capacity of the second battery.

The system, wherein, based being in a standby state and a difference between a state of charge (SoC) of a first battery of the plurality of batteries and an SoC of a second battery of the plurality of batteries exceeding a preset threshold value, the central controller circuit is configured to control a first battery controller circuit of the plurality of battery controller circuits and a second battery controller circuit of the plurality of battery controller circuits such that one of the second battery and the first battery is balanced by transferring energy from the other of the first battery and the second battery, wherein an SoC of the one is lower than an SoC of the other.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 shows an example of a configuration diagram of a system for controlling a parallel-connected battery according to an example of the present disclosure;

FIG. 2 shows an example of a method of controlling the parallel-connected battery according to an example of the present disclosure in a charging state;

FIG. 3 shows an example of an operation method of the system for controlling the parallel-connected battery according to an example of the present disclosure in the charging state;

FIG. 4 shows an example of the method of controlling the parallel-connected battery according to an example of the present disclosure in a discharging state;

FIG. 5 shows an example of a first operation method of the system for controlling the parallel-connected battery according to an example of the present disclosure in the discharging state;

FIG. 6 shows an example of a second operation method of the system for controlling the parallel-connected battery according to an example of the present disclosure in the discharging state;

FIG. 7 shows an example of the method of controlling the parallel-connected battery according to an example of the present disclosure in a standby state;

FIG. 8 shows an example of an operation method of the system for controlling the parallel-connected battery according to an example of the present disclosure in the standby state;

FIG. 9 shows an example of the method of controlling the parallel-connected battery according to an example of the present disclosure in a safety diagnosis state;

FIG. 10 shows an example of a first operation method of the system for controlling the parallel-connected battery according to an example of the present disclosure in the safety diagnosis state; and

FIG. 11 shows an example of a second operation method of the system for controlling the parallel-connected battery according to an example of the present disclosure in the safety diagnosis state.

### DETAILED DESCRIPTION

Hereinafter, reference will be made in detail to examples of the present disclosure, examples of which are shown in the accompanying drawings and described below, and wherever possible, the same or similar elements will be denoted by the same reference numerals even though they are depicted in different drawings and a redundant description thereof will thus be omitted. In the following description of the examples, suffixes, such as “module”, and “part”, are provided or used interchangeably merely in consideration of ease in statement of the specification, and do not have meanings or functions distinguished from one another. In the following description of the examples of the present disclosure, a detailed description of known functions and configurations incorporated herein will be omitted when it may make the subject matter of the present disclosure rather unclear. Further, the accompanying drawings will be exemplarily given to describe the examples of the present disclosure, and should not be construed as being limited to the examples set forth herein, and it will be understood that the examples of the present disclosure are provided only to completely disclose the disclosure and cover modifications, equivalents or alternatives which come within the scope and technical range of the disclosure.

In the following description of the examples, terms, such as “first” and “second”, are used only to describe various elements, and these elements should not be construed as being limited by these terms. These terms are used only to distinguish one element from other elements.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

According to the present disclosure, electric vehicles (EVs)' affordability, flexibility, and efficiency may be improved through a swappable battery system that uses DC-DC converters for parallel battery connections. As EV market growth slows due to high costs and long charging times, this proposed solution may reduce a size and cost of a main battery, while allowing users to supplement the main battery with additional swappable batteries as desired. The system may use advanced control strategies to balance energy between batteries of varying states (e.g., charge levels or health) and improve voltage and power distribution for charging and discharging. This approach may not only lower EV prices and shorten charging times but also support extended driving ranges if desired.

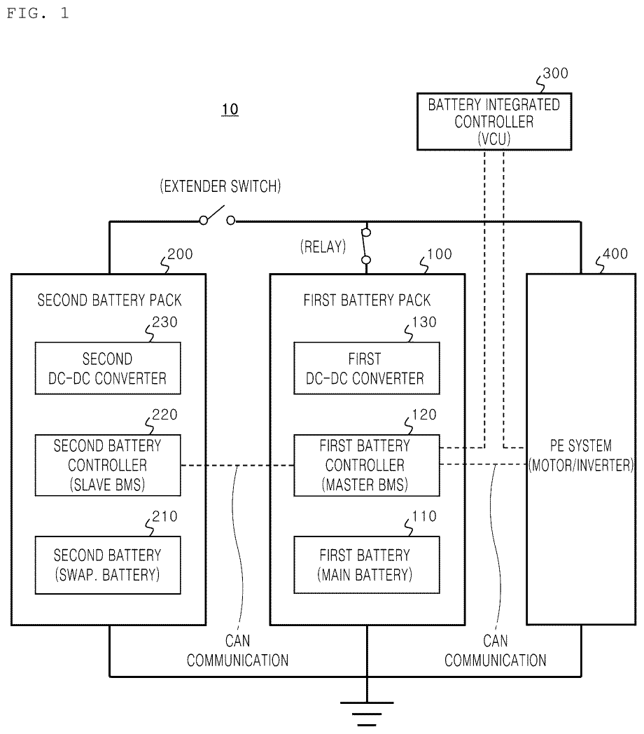

Hereinafter, a system and method for controlling a parallel-connected battery according to the present disclosure will be described in detail with reference to FIGS. 1 to 11.

FIG. 1 shows an example of a configuration diagram of the system for controlling the parallel-connected battery according to an example of the present disclosure.

Referring to FIG. 1, a parallel-connected battery control system 10 according to an example of the present disclosure includes a first battery pack 100, a second battery pack 200, a battery integrated controller 300, a power electric (PE) system 400, etc.

The system 10 incorporates a communication protocol between the master battery management system (BMS) 120 (e.g., a first battery controller circuit), slave BMS 220 (e.g., a second battery controller circuit), vehicle control unit (VCU) 300 (e.g., a battery integrated controller circuit), and DC-DC converters 130/230 to facilitate operations of the system 10. The slave BMS 220 may monitor the state information of a swappable battery 210 (e.g., a second battery), comprising state of charge (SoC), state of health (SoH), voltage, and temperature, and transmit this data to the master BMS 120. The master BMS 120 may aggregate the state information of both a main battery 110 (e.g., a first battery) and the swappable battery 210 and communicate the combined data to the VCU 300 via a controller area network (CAN) communication link. This communication structure ensures accurate, real-time monitoring of battery parameters and provides the VCU 300 with the information used to make control decisions.

The VCU 300 processes the aggregated state information to calculate total available energy, remaining driving range, and optimal system voltage demands. Based on this analysis, the VCU 300 may issue control commands to the DC-DC converters to adjust the voltage levels of the swappable battery 210, enabling efficient energy transfer and balancing. For example, if a voltage mismatch is detected, the VCU 300 may direct the DC-DC converter to step up or step down the swappable battery voltage to match the system's demands. Once the voltage difference between the main battery 110 and the swappable battery 210 falls within a threshold voltage value (e.g., 10 volts), the extender switch closes, causing the integration of the batteries into the high-voltage system. This coordinated communication process ensures safe and efficient battery management, especially in scenarios involving dynamic charging, discharging, or balancing operations.

In addition to energy management, the communication protocol may also support diagnostic and fault-handling functions. If the slave BMS 220 detects a fault condition, such as overheating or a significant SoC deviation, the slave BMS 220 may transmit the fault data to the VCU 300 via the master BMS 120. The VCU 300 then may evaluate the fault data and initiate corrective actions, such as isolating the swappable battery 210 from the system 10 or adjusting its operating parameters. These communication steps may enable the system 10 to promptly respond to faults and maintain overall operational stability.

The first battery pack 100 is a main battery pack of the parallel-connected battery control system 10, and may be implemented, for example, as a main battery pack fixedly mounted in an electric vehicle.

According to an example of the present disclosure, the first battery pack 100 may include a first battery 110, a first battery controller 120, a first DC-DC converter 130, etc. The first battery 110 may be implemented as a main battery in which one or more battery cells are connected in series and/or in parallel to provide a voltage and charging capacitance of desired performance, the first battery controller 120 may be implemented as, for example, a master battery management system (BMS) that acquires state information of a voltage, a temperature, a current, a state of charge (SoC), a state of health (SoH), etc. for the first battery 110 and controls charging and discharging, etc. of the first battery 110, and the first DC-DC converter 130 may be implemented as a converter that converts a voltage of direct current (DC) of the first battery 110 and supplies a stepped-up/stepped-down DC to the outside, or converts a voltage of DC supplied from the outside and supplies a step-down/step-up DC to the first battery 110 under the control of the first battery controller 120.

The second battery pack 200 is a battery pack connected in parallel to the first battery pack 100 of the parallel-connected battery control system 10 to assist the first battery pack 100, and may be implemented as, for example, a swappable battery pack detachably mounted in the electric vehicle.

According to an example of the present disclosure, the second battery pack 200 may include a second battery 210, a second battery controller 220, a second DC-DC converter 230, etc. The second battery 210 may be implemented as an auxiliary battery in which one or more battery cells are connected in series and/or in parallel to provide a voltage and charging capacitance of desired performance, the second battery controller 220 may be implemented as, for example, a slave BMS that acquires state information of a voltage, a temperature, a current, an SoC, an SoH, etc. for the second battery 210 and controls charging and discharging, etc. of the second battery 210, and the second DC-DC converter 230 may be implemented as a converter that converts a voltage of DC for the second battery 210 and supplies a stepped-up/stepped-down DC to the outside, or converts a voltage of DC supplied from the outside and supplies a stepped-down/stepped-up DC to the second battery 210 under the control of the second battery controller 220.

The battery integrated controller 300 is linked with the first battery controller 120 and the second battery controller 220 to acquire state information (for example, voltage, temperature, current, SoC, SoH) of the first battery 110 and state information of the second battery 210, and controls the first battery controller 120 and the second battery controller 220 based thereon, thereby comprehensively controlling charging and discharging of the first battery 110 and the second battery 210.

For example, the battery integrated controller 300 checks voltages of the first and second batteries 110 and 210 from the state information of the first and second batteries 110 and 210, determines a voltage step-up/step-down level for the first battery 110 to transmit the voltage step-up/step-down level to the first battery controller 120, and determines a voltage step-up/step-down level for the second battery 210 to transmit the voltage step-up/step-down level to the second battery controller 220 to optimally operate the first and second batteries 110 and 210. Then, the first battery controller 120 controls the first DC-DC converter 130 so that the DC of the first battery 110 is stepped up/stepped down, and the second battery controller 220 controls the second DC-DC converter 230 so that the DC of the second battery 210 is stepped up/stepped down.

In addition, the battery integrated controller 300 checks the SoCs of the first and second batteries 110 and 210 from the state information of the first and second batteries 110 and 210, and controls the first and second battery controllers 120 and 220 based on the SoCs of the first and second batteries 110 and 210 so that the first battery 110 is charged alone, the second battery 210 is charged alone, the first and second batteries are simultaneously charged, maximum output of the first battery 110 is performed, maximum output of the second battery 210 is performed, output of the first battery 110 is supported, output of the second battery 210 is supported, the first battery 110 is balanced, and the second battery 210 is balanced.

For reference, the battery integrated controller 300 may be implemented as a vehicle control unit (VCU) that controls the vehicle when the first and second battery packs 100 and 200 are mounted and used in the electric vehicle.

The PE system 400 is a device that converts electrical energy into mechanical energy and uses the energy by using power supplied from the first battery pack 100 and/or the second battery pack 200, and/or converts mechanical energy generated by the PE system 400 into electrical energy and supplies the electrical energy to the first battery pack 100 and/or the second battery pack 200.

For reference, when the first and second battery packs 100 and 200 are mounted and used in the electric vehicle, the PE system 400 may be implemented in a form that includes a motor, an inverter, a reducer, etc. that drives the vehicle.

Meanwhile, referring to FIG. 1, the first battery pack 100 may be connected to or disconnected from the PE system 400, for example, by turning on/off a relay, and the second battery pack 200 may be connected to or disconnected from the PE system 400, for example, by turning on/off an extender switch. When both the extender switch and the relay are turned on, the second battery pack 200 may be connected in parallel to the first battery pack 100 and used as an auxiliary battery.

In addition, the first battery controller 120, the second battery controller 220, the battery integrated controller 300, and the PE system 400 may communicate with each other using, for example, controller area network (CAN) communication.

For example, the second battery controller 220 provides state information of the second battery 210 to the first battery controller 120 through CAN communication, and the first battery controller 120 provides state information of the first battery 110 and state information of the second battery 210 to the battery integrated controller 300 through CAN communication. Then, the battery integrated controller 300 determines charging/discharging, voltage step-up/step-down, etc. of the first battery 110 and the second battery 210 based on the state information of the first battery 110 and the state information of the second battery 210, and similarly transmits control commands for charging/discharging, voltage step-up/step-down, etc. to the first battery controller 120 and the second battery controller 220 through CAN communication, thereby controlling the first battery 110 and the second battery 210 in an integrated manner.

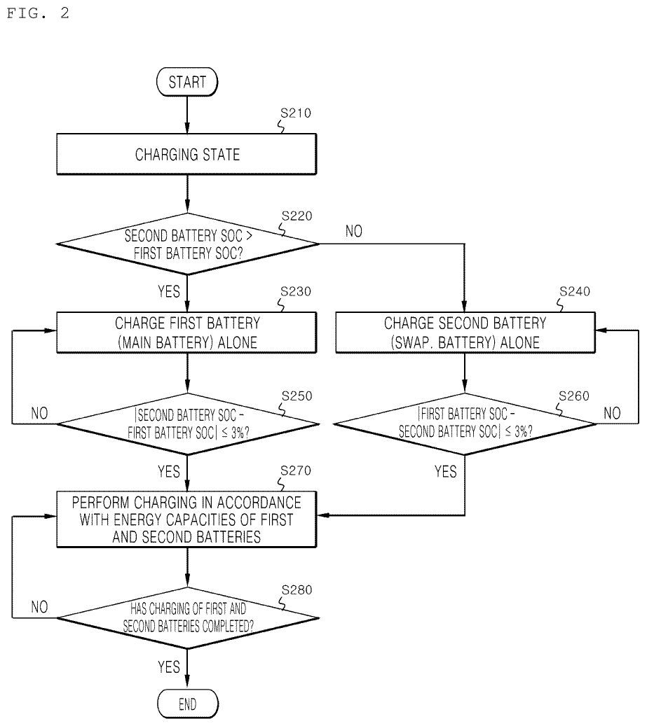

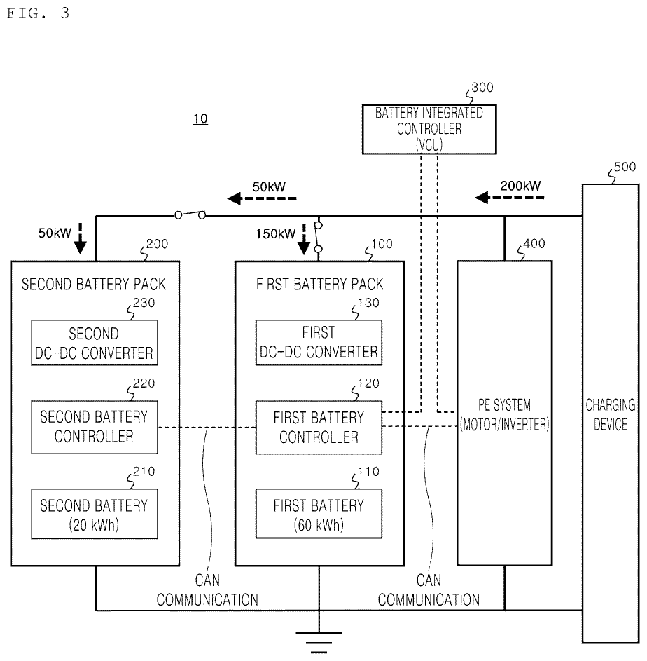

Hereinafter, an operation method of the parallel-connected battery control system according to an example of the present disclosure in a charging state will be described with reference to FIG. 2 and FIG. 3.

FIG. 2 shows an example of a method of controlling the parallel-connected battery according to an example of the present disclosure in the charging state, and FIG. 3 shows an example of an operation method of the parallel-connected battery control system according to an example of the present disclosure in the charging state.

Referring to FIGS. 2 and 3, in the case of the charging state in which the first and second battery packs 100 and 200 are connected to a charging device 500 and charged (see step S210), the battery integrated controller 300 checks the state information of the first battery 110 transmitted from the first battery controller 120 and the state information of the second battery 210 transmitted from the second battery controller 220, and compares the SoC of the first battery 110 with the SoC of the second battery 210 (see step S220).

If the SoC of the second battery 210 is greater than the SoC of the first battery 110 as a result of comparison in step S220, the battery integrated controller 300 controls the first and second battery controllers 120 and 220 so that the first battery 110 is charged alone (see step S230). Further, a difference between the SoC of the second battery 210 and the SoC of the first battery 110 is compared with a preset threshold value (for example, 3%) periodically or under a preset condition (see step S250), and if the difference between the SoC of the second battery 210 and the SoC of the first battery 110 exceeds the preset threshold value, the first battery 110 continues to be charged alone (see step S230). On the other hand, if the difference between the SoC of the second battery 210 and the SoC of the first battery 110 is less than or equal to the preset threshold value, charging is performed in accordance with energy capacity of the first and second batteries 110 and 210 (see step S270). For example, in the case where the energy capacity of the first battery 110 is 60 kWh and the energy capacity of the second battery 210 is 20 kWh, when the charging device 500 supplies power of 200 kW, the first battery 110 is charged with power of 150 kW, and the second battery 210 is charged with power of 50 kW (see FIG. 3).

On the other hand, if the SoC of the second battery 210 is not greater than the SoC of the first battery 110 as a result of comparison in step S220, the battery integrated controller 300 controls the first and second battery controller 120 and 220 so that the second battery 210 is charged alone (see step S240). Further, a difference between the SoC of the first battery 110 and the SoC of the second battery 210 is compared with a preset threshold value (for example, 3%) periodically or under a preset condition (see step S260), and if the difference between the SoC of the first battery 110 and the SoC of the second battery 210 exceeds the preset threshold value, the second battery 210 continues to be charged alone (see step S240). On the other hand, if the difference between the SoC of the first battery 110 and the SoC of the second battery 210 is less than or equal to the preset threshold value, charging is performed in accordance with energy capacity of the first and second batteries 110 and 210 (see step S270).

Further, it is determined whether charging of the first and second batteries 110 and 210 is completed periodically or according to a preset condition (see step S280), and when charging is completed, the battery integrated controller 300 controls the first and second battery controllers 120 and 220 so that charging of the first and second batteries 110 and 210 is ended.

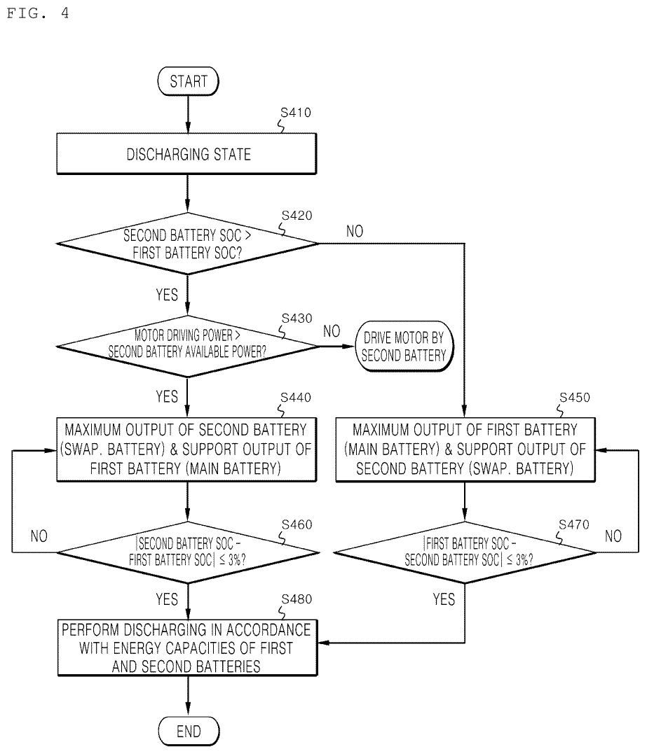

Hereinafter, a description will be given of an operation method of the parallel-connected battery control system according to an example of the present disclosure in a discharging state (for example, a driving state) with reference to FIGS. 4 to 6.

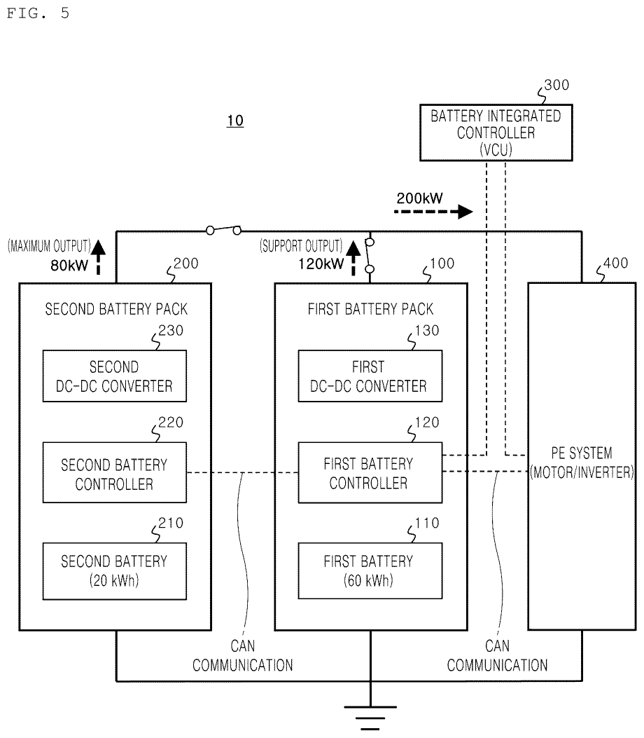

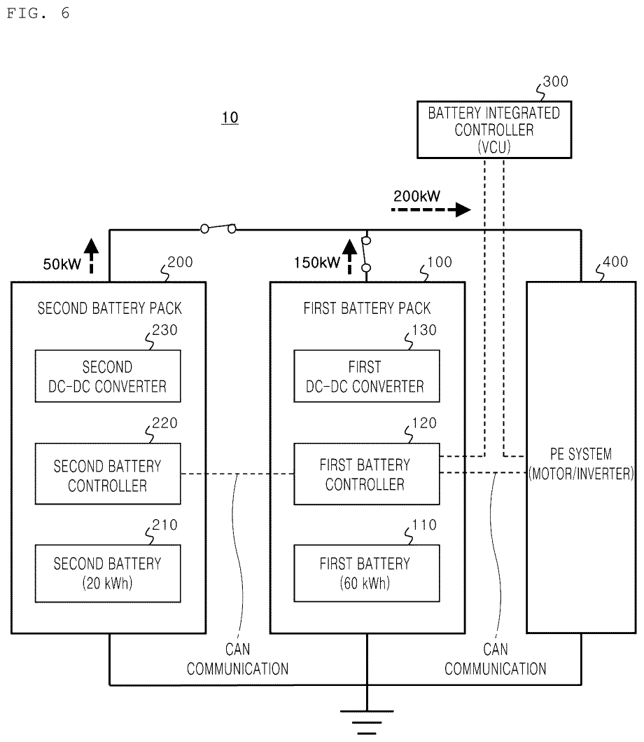

FIG. 4 shows an example of the method of controlling the parallel-connected battery according to an example of the present disclosure in the discharging state, FIG. 5 shows an example of a first operation method of the parallel-connected battery system according to an example of the present disclosure in the discharging state, and FIG. 6 shows an example of a second operation of the parallel-connected battery system according to an example of the present disclosure in the discharging state.

Referring to FIGS. 4 to 6, if the first and second battery packs 100 and 200 are in the discharging state in which power is supplied to the PE system 400 (see step S410), the battery integrated controller 300 checks the state information of the first battery 110 transmitted from the first battery controller 120 and the state information of the second battery 210 transmitted from the second battery controller 220, and compares the SoC of the first battery 110 with the SoC of the second battery 210 (see step S420).

if the SoC of the second battery 210 is greater than the SoC of the first battery 110 as a result of comparison in step S420, driving power of the motor, etc. is compared with available power of the second battery 210 (see step S430), and if the available power of the second battery 210 is greater than or equal to the driving power of the motor, etc., the battery integrated controller 300 controls the first and second battery controllers 120 and 220 so that the second battery 210 alone drives the motor, etc.

If the driving power of the motor, etc. is greater than the available power of the second battery 210, the battery integrated controller 300 controls the first and second battery controllers 120 and 220 so that output of the second battery 210 is maximized, and the first battery 110 supports output (see step S440). For example, when power of 200 kW is supplied to the PE system 400, and maximum output of the second battery 210 is 80 kW, the second battery 210 supplies power at a maximum output of 80 kW, and the first battery 110 supplies power at an output of 120 kW (see FIG. 5).

Further, a difference between the SoC of the second battery 210 and the SoC of the first battery 110 is compared with a preset threshold value (for example, 3%) periodically or under a preset condition (see step S460), and if the difference between the SoC of the second battery 210 and the SoC of the first battery 110 exceeds the preset threshold value, similarly, output of the second battery 210 is maintained at maximum, and the first battery 110 supports output (see step S440).

If the difference between the SoC of the second battery 210 and the SoC of the first battery 110 is less than or equal to the preset threshold value, discharging is performed in accordance with energy capacities of the first and second batteries 110 and 210 (see step S480). For example, in the case where energy capacity of the first battery 110 is 60 kWh, and energy capacity of the second battery 210 is 20 kWh, when power of 200 kW is supplied to the PE system 400, the first battery 110 supplies power at output of 150 kW, and the second battery 210 supplies power at an output of 50 kW (see FIG. 6).

On the other hand, if the SoC of the second battery 210 is not greater than the SoC of the first battery 110 as a result of comparison in step S420, the battery integrated controller 300 controls the first and second battery controllers 120 and 220 so that output of the first battery 110 is maximized, and the second battery 210 supports output (see step S450).

Further, the difference between the SoC of the first battery 110 and the SoC of the second battery 210 is compared with the preset threshold value (for example, 3%) periodically or under a preset condition (see step S470), and when the difference between the SoC of the first battery 110 and the SoC of the second battery 210 exceeds the preset threshold value, similarly, output of the first battery 110 is maintained at maximum, and the second battery 210 supports output (see step S450).

On the other hand, if the difference between the SoC of the first battery 110 and the SoC of the second battery 210 is less than or equal to the preset threshold value, discharging is performed in accordance with energy capacities of the first and second batteries 110 and 210 (see step S480).

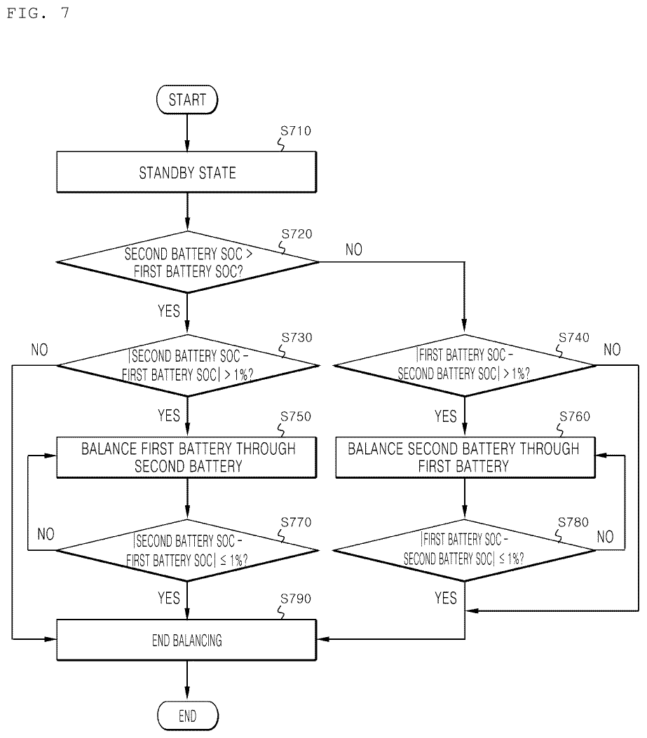

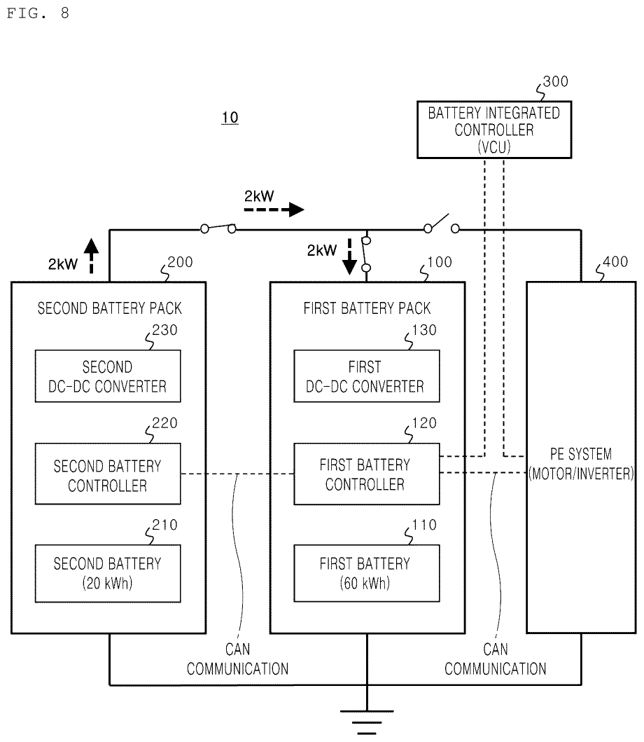

Hereinafter, a description will be given of an operation method of the parallel-connected battery control system according to an example of the present disclosure in a standby state (for example, parking state) with reference to FIGS. 7 and 8.

FIG. 7 shows an example of the method of controlling the parallel-connected battery according to an example of the present disclosure in the standby state, and FIG. 8 shows an example of an operation method of the parallel-connected battery system according to an example of the present disclosure in the standby state.

Referring to FIGS. 7 and 8, in the case of the standby state in which the first and second battery packs 100 and 200 do not perform charging and discharging for the PE system 400 (see step S710), the battery integrated controller 300 checks the state information of the first battery 110 transmitted from the first battery controller 120 and the state information of the second battery 210 transmitted from the second battery controller 220, and compares the SoC of the first battery 110 with the SoC of the second battery 210 (see step S720).

If the SoC of the second battery 210 is greater than the SoC of the first battery 110 as a result of comparison in step S720, the battery integrated controller 300 compares a difference between the SoC of the second battery 210 and the SoC of the first battery 110 with a preset threshold value (for example, 1%) (see step S730), and balances the first battery 110 through the second battery 210 if the difference between the SoC of the second battery 210 and the SoC of the first battery 110 exceeds the preset threshold value (see step S750). For example, when the energy capacity of the first battery 110 is 60 kWh and the energy capacity of the second battery 210 is 20 kWh, considering a parking situation where cooling is not performed, balancing of the first battery 110 is performed through the second battery 210 with power less than or equal to 10% (for example, 2 kW) based on the energy capacity of the second battery 210 having lower energy capacity (see FIG. 8).

In addition, the difference between the SoC of the second battery 210 and the SoC of the first battery 110 is compared with the preset threshold value periodically or under a preset condition (see step S770), and if the difference between the SoC of the second battery 210 and the SoC of the first battery 110 is less than or equal to the preset threshold value, the extender switch is opened to end battery balancing (see step S790). On the other hand, if the difference between the SoC of the second battery 210 and the SoC of the first battery 110 less than or equal to the preset threshold value in step S730, the extender switch is similarly opened to end battery balancing (see step S790).

On the other hand, if the SoC of the second battery 210 is not greater than the SoC of the first battery 110 as a result of comparison in step S720, the battery integrated controller 300 compares the difference between the SoC of the first battery 110 and the SoC of the second battery 210 with a preset threshold value (for example, 1%) (see step S740), and if the difference between the SoC of the first battery 110 and the SoC of the second battery 210 exceeds the preset threshold value, the second battery 210 is balanced through the first battery 110 (see step S760). For example, when the energy capacity of the first battery 110 is 60 kWh and the energy capacity of the second battery 210 is 20 kWh, the second battery 210 is balanced through the first battery 110 with power less than or equal to 10% (for example, 2 kW) based on the energy capacity of the second battery 210 having a lower energy capacity.

In addition, the difference between the SoC of the first battery 110 and the SoC of the second battery 210 is compared with the preset threshold value periodically or under a preset condition (see step S780), and if the difference between the SoC of the first battery 110 and the SoC of the second battery 210 is less than or equal to the preset threshold value, the extender switch is opened to end battery balancing (see step S790). On the other hand, if the difference between the SoC of the first battery 110 and the SoC of the second battery 210 less than or equal to the preset threshold value in step S740, the extender switch is similarly opened to end battery balancing (see step S790).

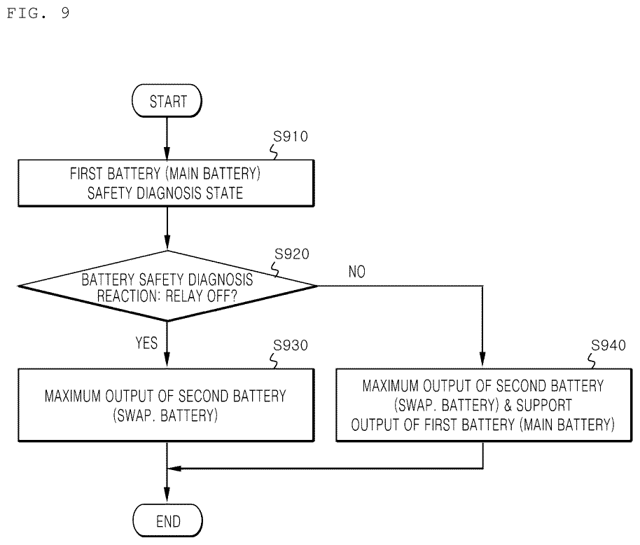

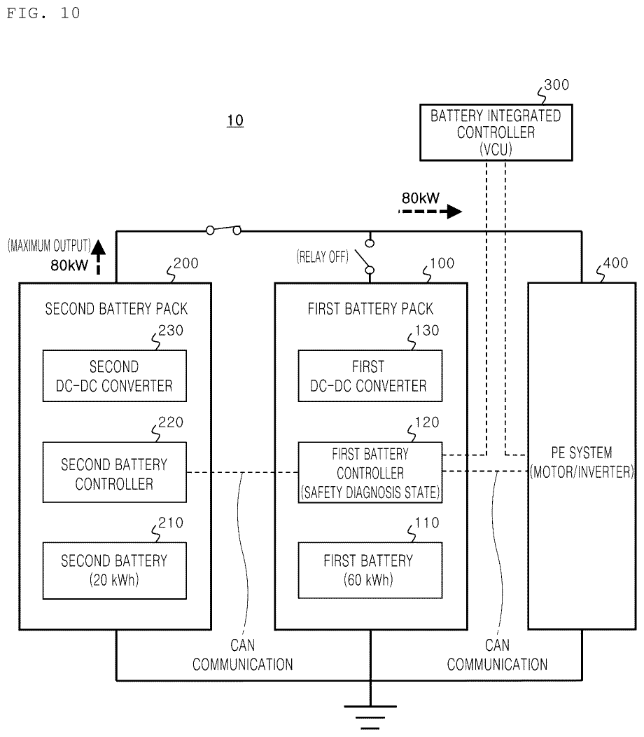

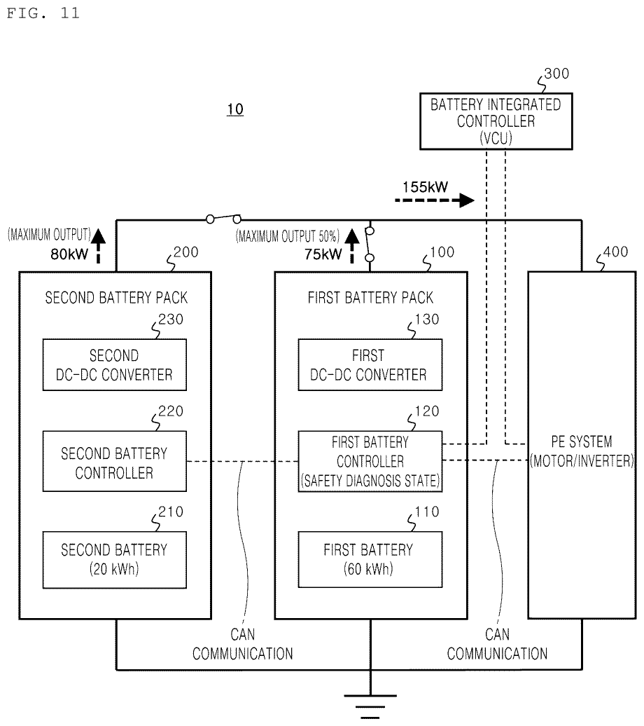

Hereinafter, a description will be given of an operation method of the parallel-connected battery control system according to an example of the present disclosure in a safety diagnosis state (for example, a main battery safety diagnosis state) with reference to FIG. 9, FIG. 10, and FIG. 11.

In a safety diagnosis state, the system may implement control strategies to ensure safe operation and system integrity. If a safety diagnosis is triggered for the main battery (e.g., due to conditions like overvoltage, undervoltage, excessive temperature, or thermal runaway, etc.), the integrated controller circuit may adjust the system operation based on the diagnosis results. For example, if the safety diagnosis causes the main battery's output to be disabled (e.g., relay-off condition), the swappable battery is configured to provide maximum output to maintain the vehicle's functionality and ensure safe operation. Further, when the safety diagnosis imposes output limitations on the main battery (e.g., restricting output to 50%), the swappable battery may supplement the main battery's output to meet system demands. These actions ensure that the system operates safely and reliably during a safety diagnosis state, even under constrained conditions.

Furthermore, in cases where safety diagnostic measures impact the overall available energy or system output, the integrated controller circuit may recalculate the remaining driving range based on the current energy availability of the swappable and main batteries. This recalculation may provide the driver with updated and accurate driving range information, ensuring proper vehicle operation during the safety diagnosis state. These safety mechanisms may be beneficial for maintaining vehicle functionality while preventing damages to the batteries or the system during diagnostic events.

FIG. 9 shows an example of the method of controlling the parallel-connected battery according to an example of the present disclosure in the safety diagnosis state, FIG. 10 shows an example of a first operation method of the parallel-connected battery control system according to an example of the present disclosure in the safety diagnosis state, and FIG. 11 shows an example of a second operation method of the parallel-connected battery control system according to an example of the present disclosure in the safety diagnosis state.

Referring to FIG. 9, FIG. 10, and FIG. 11, in the case of the safety diagnosis state due to detection of safety diagnosis of the first battery 110, which is the main battery (see step S910), the battery integrated controller 300 determines whether the relay connecting the first battery pack 100 is turned off according to a battery safety diagnosis reaction (see step S920).

If the relay connecting the first battery pack 100 is turned off, the battery integrated controller 300 controls the first and second battery controllers 120 and 220 so that output of the second battery 210 is maximized (see step S930). For example, when the maximum output of the second battery 210 is 80 kW, the second battery 210 supplies power to the PE system 400 at a maximum output of 80 kW (see FIG. 10).

On the other hand, if the relay connecting the first battery pack 100 is turned on, the battery integrated controller 300 controls the first and second battery controllers 120 and 220 so that output of the second battery 210 is maximized, and the first battery 110 supports output (see step S940). For example, when the maximum output of the first battery 110 is 150 kW and the maximum output of the second battery 210 is 80 kW, the second battery 210 supplies power to the PE system 400 at the maximum output of 80 kW and the first battery 110 supplies power to the PE system 400 with output of 75 kW, which is 50% of the maximum output (see FIG. 11).

It is another object of the present disclosure to provide a system and method for controlling a parallel-connected battery in which a main battery and a swappable battery of different types may be connected in parallel and used using a DC-DC converter.

It is a further object of the present disclosure to provide a system and method for controlling a parallel-connected battery in which a main battery and a swappable battery may be optimally controlled and used according to a current state (charging, driving, parking, safety diagnosis, etc.) of an electric vehicle.

Objects of the present disclosure are not limited to the above-mentioned object, and other objects and advantages of the present disclosure, which are not mentioned, will be understood through the following description, and will become apparent from examples of the present disclosure. It is also to be understood that the objects and advantages of the present disclosure may be realized by means and combinations thereof set forth in claims.

In accordance with an example of the present disclosure, the above and other objects can be accomplished by the provision of a system for controlling a parallel-connected battery including a first battery controller configured to acquire state information of a first battery and control the first battery, a second battery controller configured to acquire state information of a second battery connected in parallel to the first battery and control the second battery, and a battery integrated controller configured to control the first battery controller and the second battery controller based on the state information of the first battery and the state information of the second battery.

The system may further comprise a first direct current (DC)-DC converter configured to perform at least one of step-up or step-down of a voltage of the first battery under control of the first battery controller, and a second DC-DC converter configured to perform at least one of step-up or step-down of a voltage of the second battery under control of the second battery controller, wherein the battery integrated controller controls the first battery controller and the second battery controller so that the first DC-DC converter and the second DC-DC converter perform at least one of step-up or step-down based on the voltage of the first battery and the voltage of the second battery.

In accordance with another example of the present disclosure, there is provided a method of controlling a parallel-connected battery including acquiring, by a battery integrated controller, state information of a first battery and state information of a second battery connected in parallel to the first battery, and controlling, by the battery integrated controller, a first battery controller for controlling the first battery and a second battery controller for controlling the second battery based on the state information of the first battery and the state information of the second battery.

According to the present disclosure, since a swappable battery may be added to a main battery fixedly mounted in an electric vehicle, etc. as desired and used, energy capacity of the main battery may be reduced to lower the price of the electric vehicle, etc., and a charging time may be greatly shortened.

In addition, according to the present disclosure, since a main battery and a swappable battery of different types may be connected in parallel and used using a DC-DC converter, there is an effect of being able to efficiently control a main battery and a swappable battery in different SoCs and SoHs.

In addition, according to the present disclosure, there is an effect of being able to optimally control and use a main battery and a swappable battery according to a current state (charging, driving, parking, safety diagnosis, etc.) of an electric vehicle.

In the specification (particularly, in the claims) of the present disclosure, use of the term “above” and similar referential terms may refer to both the singular and the plural. In addition, when a range is stated in the present disclosure, the statement includes the disclosure to which individual values within the range are applied (unless there is a statement to the contrary), and is the same as a statement of the individual values constituting the range in the detailed description of the disclosure.

Unless there is a statement of an explicit order or a statement to the contrary regarding steps constituting the method according to the present disclosure, the steps may be performed in any appropriate order. The present disclosure is not necessarily limited by the described order of the steps. Use of any examples or illustrative terms (for example, etc.) in the present disclosure is merely to describe the present disclosure in detail, and unless limited by the claims, the scope of the present disclosure is not limited by the examples or illustrative terms. Further, those skilled in the art will appreciate that various modifications, combinations, and changes may be made according to design conditions and factors within the scope of the appended claims or their equivalents.

Therefore, the spirit of the present disclosure should not be limited to the above-described examples, and the scope of the appended claims described below as well as all scopes equivalent to or equivalently changed from the claims are within the scope of the spirit of the present disclosure.

What is claimed:

1. A system for controlling a plurality of batteries, the system comprising:
a first battery controller circuit configured to:
obtain first state information of a first battery of the plurality of batteries, and
control, based on the first state information, the first battery;
a second battery controller circuit configured to:
obtain second state information of a second battery of the plurality of batteries, and
control, based on the second state information, the second battery, wherein the second battery is coupled in parallel to the first battery; and
a battery integrated controller circuit configured to control, based on aggregated state information of the first state information and the second state information, the first battery controller circuit and the second battery controller circuit.

2. The system according to claim 1, further comprising:
a first direct current (DC)-DC converter configured to perform at least one of step-up or step-down of a first voltage of the first battery under control of the first battery controller circuit; and
a second DC-DC converter configured to perform at least one of step-up or step-down of a second voltage of the second battery under control of the second battery controller circuit.

3. The system according to claim 2, wherein the battery integrated controller circuit is configured to control the first battery controller circuit and the second battery controller circuit such that:
the first DC-DC converter performs the at least one of step-up or step-down of the first voltage, and
the second DC-DC converter performs the at least one of step-up or step-down of the second voltage.

4. The system according to claim 1, wherein, based on being in a charging state and a difference between a state of charge (SoC) of the first battery and an SoC of the second battery exceeding a preset threshold value, the battery integrated controller circuit is configured to control the first battery controller circuit and the second battery controller circuit such that either the first battery or the second battery, whichever has a lower SoC, is charged alone.

5. The system according to claim 1, wherein, based on being in a discharging state, the battery integrated controller circuit is configured to:
control, based on a state of charge (SoC) of the first battery being less than an SoC of the second battery, the first battery controller circuit and the second battery controller circuit such that the second battery generates a primary output and the first battery generates a secondary output, wherein the primary output of the second battery corresponds to a maximum output of the second battery, and
control, based on the SoC of the first battery not being less than the SoC of the second battery, the first battery controller circuit and the second battery controller circuit such that the first battery generates a primary output and the second battery generates a secondary output, wherein the primary output of the first battery corresponds to a maximum output of the first battery.

6. The system according to claim 1, wherein, based on being in a discharging state and a difference between a state of charge (SoC) of the first battery and an SoC of the second battery being less than or equal to a preset threshold value, the battery integrated controller circuit is configured to control the first battery controller circuit and the second battery controller circuit such that:
an output from the first battery is generated based on an energy capacity of the first battery, and
an output from the second battery is generated based on an energy capacity of the second battery.

7. The system according to claim 1, wherein, based being in a standby state and a difference between a state of charge (SoC) of the first battery and an SoC of the second battery exceeding a preset threshold value, the battery integrated controller circuit is configured to control the first battery controller circuit and the second battery controller circuit such that either the second battery or the first battery, whichever has a lower SoC, is balanced through either the first battery or the second battery, whichever has a higher SoC.

8. The system according to claim 1, wherein, based on being in a safety diagnosis state, the battery integrated controller circuit is configured to:
control the first battery controller circuit and the second battery controller circuit such that:
the second battery generates a primary output, corresponding to a maximum output of the second battery, regardless of whether the first battery is allowed to generate an output, and
the first battery generates, based on generating an output of the first battery being allowed in the safety diagnosis state, a secondary output.

9. A method performed by an apparatus comprising a battery integrated controller circuit, the method comprising:
obtaining, by the battery integrated controller circuit, first state information of a first battery of a plurality of batteries and second state information of a second battery of the plurality of batteries, wherein the second battery is coupled in parallel to the first battery; and
based on aggregated state information of the first state information and the second state information, controlling, by the battery integrated controller circuit, a first battery controller circuit for controlling the first battery and a second battery controller circuit for controlling the second battery.

10. The method according to claim 9, wherein, based on being in a charging state and a difference between a state of charge (SoC) of the first battery and an SoC of the second battery exceeding a preset threshold value, the controlling comprises controlling the first battery controller circuit and the second battery controller circuit such that either the first battery or the second battery, whichever has a lower SoC, is charged alone.

11. The method according to claim 9, wherein, based on being in a discharging state, the controlling comprises:
controlling, based on a state of charge (SoC) of the first battery being less than an SoC of the second battery, the first battery controller circuit and the second battery controller circuit such that the second battery generates a primary output and the first battery generates a secondary output, wherein the primary output corresponds to a maximum output of the second battery; and
controlling, based on the SoC of the first battery not being less than the SoC of the second battery, the first battery controller circuit and the second battery controller circuit such that the first battery generates a primary output and the second battery generates a secondary output, wherein the primary output of the first battery corresponds to a maximum output of the first battery.

12. The method according to claim 9, wherein, based on being in a discharging state and a difference between a state of charge (SoC) of the first battery and an SoC of the second battery being less than or equal to a preset threshold value, the controlling comprises controlling at least one of the first battery controller circuit or the second battery controller circuit such that:
an output from the first battery is generated based on an energy capacity of the first battery, or
an output from the second battery is generated based on an energy capacity of the second battery.

13. The method according to claim 9, wherein, based on being in a standby state and a difference between a state of charge (SoC) of the first battery and an SoC of the second battery exceeding a preset threshold value, the controlling comprises controlling the first battery controller circuit and the second battery controller circuit such that either the second battery or the first battery, whichever has a lower SoC, is balanced through either the first battery or the second battery, whichever has a higher SoC.

14. The method according to claim 9, wherein, based on being in a safety diagnosis state, the controlling comprises:
controlling the first battery controller circuit and the second battery controller circuit such that:
the second battery generates a primary output, corresponding to a maximum output of the second battery, regardless of whether the first battery is allowed to generate an output, and
the first battery generates, based on generating an output of the first battery being allowed in the safety diagnosis state, a secondary output.

15. A system for controlling a plurality of batteries, the system comprising:
a plurality of battery controller circuits, each configured to:
obtain respective state information of a corresponding battery of the plurality of batteries, and
control, based on the respective state information, the corresponding battery, wherein the plurality of batteries are coupled in parallel to each other; and
a central controller circuit configured to control, based on aggregated state information of the plurality of batteries, the plurality of the battery controller circuits.

16. The system according to claim 15, further comprising:
a plurality of direct current (DC)-DC converters, each configured to perform at least one of step-up or step-down of a voltage of a corresponding battery of the plurality of batteries.

17. The system according to claim 15, wherein, based on being in a charging state and a difference between a state of charge (SoC) of a first battery of the plurality of batteries and an SoC of a second battery of the plurality of batteries exceeding a preset threshold value, the central controller circuit is configured to control the plurality of battery controller circuits such that either of the first battery or the second battery, which has a lower SoC, is charged alone.

18. The system according to claim 15, wherein, based on being in a discharging state, the central controller circuit is configured to:
control, based on a state of charge (SoC) of a first battery of the plurality of batteries being less than an SoC of a second battery of the plurality of batteries, a first battery controller circuit of the plurality of battery controller circuits and a second battery controller circuit of the plurality of battery controller circuits such that the second battery generates a primary output and the first battery generates a secondary output, wherein the primary output of the second battery corresponds to a maximum output of the second battery, and
control, based on an SoC of the first battery not being less than an SoC of the second battery, the first battery controller circuit and the second battery controller circuit such that the first battery generates a primary output and the second battery generates a secondary output, wherein the primary output of the first battery corresponds to a maximum output of the first battery.

19. The system according to claim 15, wherein, based on being in a discharging state and a difference between a state of charge (SoC) of a first battery of the plurality of batteries and an SoC of a second battery of the plurality of batteries being less than or equal to a preset threshold value, the central controller circuit is configured to control a first battery controller circuit of the plurality of battery controller circuits and a second battery controller circuit of the plurality of battery controller circuits such that:
an output from the first battery is generated based on an energy capacity of the first battery, and
an output from the second battery is generated based on an energy capacity of the second battery.

20. The system according to claim 15, wherein, based being in a standby state and a difference between a state of charge (SoC) of a first battery of the plurality of batteries and an SoC of a second battery of the plurality of batteries exceeding a preset threshold value, the central controller circuit is configured to control a first battery controller circuit of the plurality of battery controller circuits and a second battery controller circuit of the plurality of battery controller circuits such that one of the second battery and the first battery is balanced by transferring energy from the other of the first battery and the second battery, wherein an SoC of the one is lower than an SoC of the other.
